(19) United States
(12) Patent Application Publication
(10) Pub. No.: US 2021/0384805 A1
(43) Pub. Date: Dec. 9, 2021

(54) METHOD FOR MANUFACTURING STATOR

(71) Applicant: HITACHI AUTOMOTIVE SYSTEMS, LTD., Hitachinaka-shi, Ibaraki (JP)

(72) Inventors: Shingo KITAJIMA, Hitachinaka-shi (JP); Hisaya SHIMIZU, Hitachinaka-shi (JP); Takayuki KOIZUMI, Hitachinaka-shi (JP); Seigo MISAKI, Hitachinaka-shi (JP)

(73) Assignee: HITACHI AUTOMOTIVE SYSTEMS, LTD., Hitachinaka-shi, Ibaraki (JP)

(21) Appl. No.: 16/772,878

(22) PCT Filed: Nov. 26, 2018
(86) PCT No.: PCT/JP2018/043323

§ 371 Date: Jun. 15, 2020

(30) Foreign Application Priority Data
Dec. 21, 2017 (JP) 2017-244623

(51) Int. Cl. H02K 15/00; H02K 15/04; H02K 15/02; H02K 15/06; H02K 15/12

(52) U.S. Cl. CPC H02K 15/0087; H02K 15/0421; H02K 15/12; H02K 15/064; H02K 15/024

(57) ABSTRACT

An object of the invention is to provide a method for manufacturing a stator of a rotating electric machine that can reduce the size of a coil end. According to the invention, a method for manufacturing a stator, which includes a stator core and a stator coil to which ends of a plurality of substantially U-shaped segment coils inserted into slots of the stator core are connected, includes twisting the end of the segment coil using a twisting jig 600. In the twisting, in a state in which the end of the segment coil is inserted into a groove portion 610 of the twisting jig, an edge portion 620 forming a part of the groove portion 610 is used as a twisting fulcrum, and a load is applied to the segment coil to forma press trace of the edge portion on the segment coil.

### TECHNICAL FIELD

The present invention relates to a method for manufacturing a stator of a rotating electric machine.

### BACKGROUND ART

In a rotating electric machine, a rotating magnetic field is generated by supplying AC power to a stator winding, and a rotor rotated by the rotating magnetic field. Further, it is also possible to convert mechanical energy applied to the rotor into electric energy and output AC power from the coil. Thus, the rotating electric machine operates as an electric motor or a generator. As a stator of such a rotating electric machine, a configuration in which ends of segment coils are connected by welding is known (for example, see Patent Document 1).

### CITATION LIST

### Patent Literature

PTL 1: JP 2004-135438 A

### SUMMARY OF INVENTION

### Technical Problem

When this type of rotating electric machine is mounted on an automobile, minimization is required to mount the electric rotating machine in a limited narrow space. With the miniaturization, the coil end needs to be reduced. After inserting the approximately U-shaped segment conductor into a slot, the stator coil is formed by twist-molding and welding. In order to further reduce the size of the welding-side coil end, it is necessary to sharpen the twisting angle of the coil twisting portion, and it is necessary to further increase a twisting load during the twist-molding. On the other hand, when the twisting load is increased, the twisting jig and the coil are likely to be displaced during the twist-molding, and the height and position of the coil end are displaced. In addition, displacement of the coil end in the height direction, circumferential direction or radial direction causes problems such as a decrease in workability in a subsequent welding process of the coil end and a decrease in connection reliability of the welded portion. A low coil end cannot be achieved due to variations in height.

An object of the invention is to provide a method for manufacturing a stator of a rotating electric machine that can reduce the size of a coil end.

### Solution to Problem

According to the invention, a method for manufacturing a stator, which includes a stator core and a stator coil to which ends of a plurality of substantially U-shaped segment coils inserted into slots of the stator core are connected, includes twisting the end of the segment coil using a twisting jig. In the twisting, in a state in which the end of the segment coil is inserted into a groove portion of the twisting jig, an edge portion forming a part of the groove portion is used as a twisting fulcrum, and a load is applied to the segment coil to forma press trace of the edge portion on the segment coil.

### Advantageous Effects of Invention

With a method for manufacturing a stator of a rotating electric machine according to the invention, the size of the coil end can be reduced.

### BRIEF DESCRIPTION OF DRAWINGS

FIG. 1 is a cross-sectional view illustrating an entire configuration of a rotating electric machine including a stator.

FIG. 2 is a perspective view illustrating a configuration of the stator.

FIG. 3 is a diagram for describing segment conductors of a stator coil, in which FIG. 3(a) is a diagram illustrating one segment conductor, FIG. 3(b) is a diagram for describing coil formation by the segment conductors, and FIG. 3(c) is a diagram for describing an arrangement of the segment conductors in a slot.

FIG. 4 is a perspective view illustrating a U-phase stator coil.

FIG. 5 is a partially enlarged view of a welding-side coil end.

FIG. 6 is a conceptual diagram illustrating a coil twisting step using a twisting jig of this embodiment.

FIG. 7 is a conceptual diagram illustrating a coil twisting step using the twisting jig of this embodiment.

FIG. 8 is a conceptual diagram illustrating a coil twisting step using the twisting jig of this embodiment.

### DESCRIPTION OF EMBODIMENTS

Hereinafter, embodiments of the invention will be described using the drawings.

### First Embodiment

In the following description, an electric motor used for a hybrid vehicle is used as an example of the rotating electric machine. In the following description, an “axial direction” refers to a direction along the rotating shaft of a rotating electric machine. The circumferential direction indicates a direction along the rotation direction of the rotating electric machine. “Radial direction” refers to the rotary radial direction (radial direction) with the rotating shaft of the rotating electric machine as the center. The “inner peripheral side” indicates the radially inner side (inner diameter side), and the “outer peripheral side” indicates the opposite direction, that is, the radially outer side (outer diameter side).

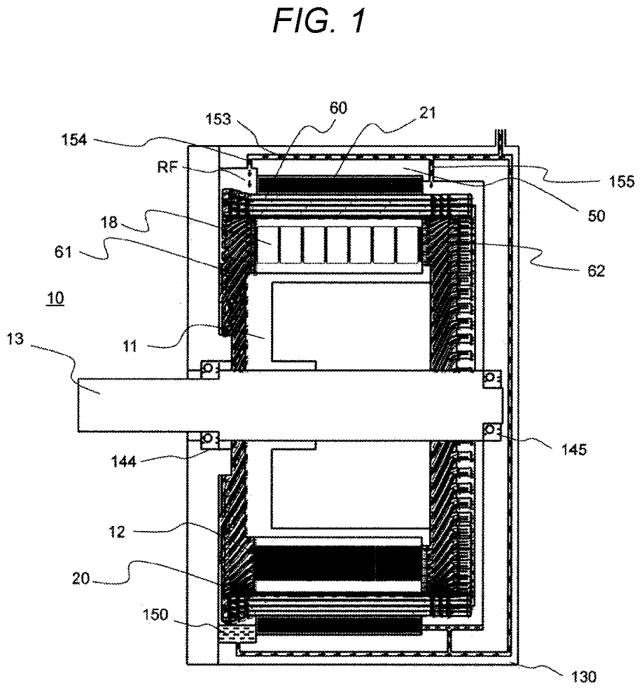

FIG. 1 is a cross-sectional view illustrating a rotating electric machine including a stator according to the invention. A rotating electric machine 10 includes a housing 50, a stator 20, a stator core 21, a stator coil 60, and a rotor 11.

The stator 20 is fixed to the inner peripheral side of the housing 50. On the inner peripheral side of the stator 20, the rotor 11 is rotatably supported. The housing 50 is configured by an electric motor casing formed by cutting a ferrous material such as carbon steel, by casting cast steel or an aluminum alloy, or by pressing to form a cylindrical shape. The housing 50 is also called a frame member or a frame.

A liquid cooling jacket 130 is fixed to the outer peripheral side of the housing 50.

The inner peripheral wall of the liquid cooling jacket 130 and the outer peripheral wall of the housing 50 form a refrigerant passage 153 for a liquid refrigerant RF such as oil or ATF (automatic transmission fluid). The refrigerant passage 153 is formed so as not to leak. The liquid cooling jacket 130 houses bearings 144 and 145 and is also called a bearing bracket.

In the case of direct liquid cooling, the refrigerant RF passes through the refrigerant passage 153, flows out from the refrigerant outlets 154 and 155 toward the stator 20, and cools the stator 20. The stator 20 may be directly bolted or shrink-fitted to the case without the housing 50.

The stator 20 is configured by a stator core 21 and a stator coil 60. The stator core 21 is formed by stacking thin sheets of silicon steel plates. The stator coil 60 is wound around a large number of slots 15 provided on the inner periphery of the stator core 21. Heat generated from the stator coil 60 is transmitted to the liquid cooling jacket 130 via the stator core 21 and is radiated by the refrigerant RF flowing through the liquid cooling jacket 130.

The rotor 11 includes a rotor core 12 and a rotating shaft 13. The rotor core 12 is formed by laminating thin plates of silicon steel plates. The rotating shaft 13 is fixed to the center of the rotor core 12. The rotating shaft 13 is rotatably held by the bearings 144 and 145 attached to the liquid cooling jacket 130, and rotates at a predetermined position inside the stator 20 where facing the stator 20.

Further, the rotor 11 is provided with a permanent magnet 18 and an end ring (not illustrated).

To assemble the rotating electric machine, the stator 20 is inserted into the housing 50 in advance and attached to the inner peripheral wall of the housing 50, and then the rotor 11 is inserted into the stator 20. Next, the bearings 144 and 145 are fitted to the liquid cooling jacket 130 such that the bearings 144 and 145 are fitted to the rotating shaft 13.

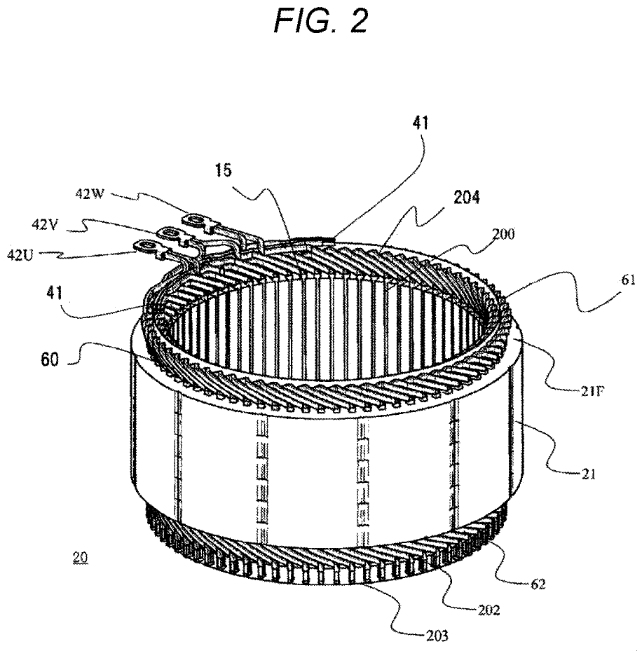

The detailed configuration of the main part of the stator 20 used in the rotating electric machine 10 according to this embodiment will be described with reference to FIG. 2. The stator 20 is configured by the stator core 21 and the stator coil 60 wound around a plurality of slots 15 provided on the inner periphery of the stator core. The stator coil 60 uses a conductor (copper wire in this embodiment) having a substantially rectangular cross section to improve a space factor in the slot, thereby improving the efficiency of the rotating electric machine 10.

The stator core 21 is provided with, for example, 72 slots 15 that open on the inner diameter side in the circumferential direction. A slot liner 200 is provided in each slot 15 to ensure electrical insulation between the stator core 21 and the stator coil 60.

The slot liner 200 is formed in a B shape or an S shape so as to wrap a copper wire. A varnish 204 is dropped to fix the stator core 21, the stator coil 60, and the slot liner 200. The varnish 204 penetrates into the gap between the stator core 21, the stator coil 60, and the slot liner 200 to perform fixing, insulation, and insulation protection. The varnish 204 uses a polyester resin or an epoxy resin varnish.

The varnish 204 penetrates into the slot 15. Further, the coil ends 61 and 62 may be applied with the varnish 204 as needed. As a method for applying the varnish 204, a dropping impregnation method using a nozzle or a method for dipping the stator in the varnish liquid surface may be used.

The coil ends 61 and 62 are used by being annularly disposed between segment conductors for interphase insulation and interconductor insulation. Thus, in the stator 20 according to this embodiment, since an insulating paper 203 is provided in the coil end 61 and the coil end 62, even if the insulating film is damaged or deteriorated, the required dielectric withstand can be held. The insulating paper 203 is, for example, an insulating sheet of heat-resistant polyamide paper, and has a thickness of about 0.1 to 0.5 mm.

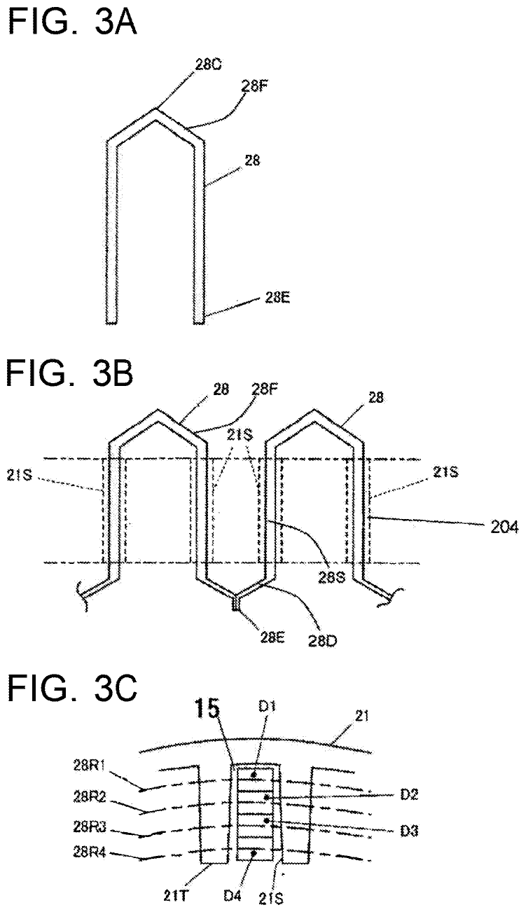

A method for winding the stator coil 60 will be briefly described with reference to FIG. 3. A copper or aluminum wire insulated with enamel, which is in a rectangular cross section, is molded to a substantially U-shaped segment conductor 28 having a non-welding-side coil end vertex 28C as a bent point as illustrated in FIG. 3(a). At this time, the non-welding-side coil end vertex 28C may have a substantially U-shaped shape in which the direction of the conductor is turned back. That is, as illustrated in FIG. 3, the shape is not limited to the shape in which the non-welding-side coil end vertex 28C and a conductor oblique portion 28F of the non-welding side non-welding-side coil end form a substantially triangle when viewed from the radial direction. For example, at a part of the non-welding-side coil end vertex 28C, a shape such that the conductor is substantially parallel to the end surface of the stator core 21 (when viewed from the radial direction, the non-welding-side coil end vertex 28C and the conductor oblique portion 28F of the non-welding-side coil end form a substantially trapezoidal shape).

The segment conductor 28 is inserted into the stator slot from the axial direction.

Then, the end of the segment conductor 28 protruding from the other end of the stator slot is twist-molded into a predetermined shape. As illustrated in FIG. 3(b), another segment conductor 28 inserted at a predetermined number of slots away is connected to a conductor welding portion 28E. The connection method is, for example, fusion bonding, liquid-solid reaction bonding, or solid-phase bonding. Mainly TIG welding and plasma welding are used.

At this time, the segment conductor 28 is formed with a conductor straight portion 28S that is a portion to be inserted into the slot 15, and a conductor oblique portion 28D that is a portion inclined toward the conductor welding portion 28E of a mating segment conductor. Two, four, six, . . . (a multiple of 2) segment conductors are inserted into the slot. FIG. 3(c) illustrates an example in which four segment conductors are inserted into one slot. However, since the conductor has a substantially rectangular cross section, the space factor in the slot can be improved, and the efficiency of the rotating electric machine is improved.

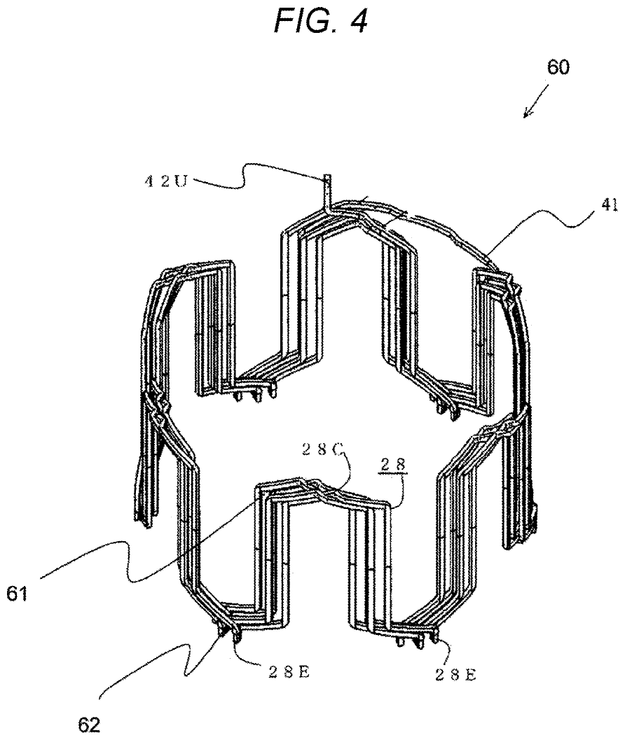

FIG. 4 is a diagram when the connection operation of FIG. 3(b) is repeated until the segment conductor becomes annular, and a coil 40 for one phase (for example, U phase) is formed. The coil 40 for one phase is configured such that the conductor ends 28E are gathered in one axial direction, and form a welding-side coil end 62 where the conductor ends 28E gather and a non-welding-side coil end 61.

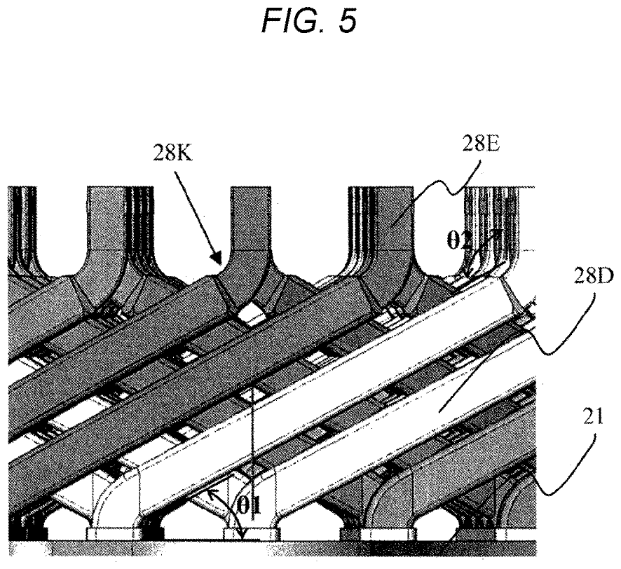

FIG. 5 illustrates an enlarged view of the welding-side coil end 62. The welding-side coil end 62 is configured by welding the ends of the in-phase segment conductors adjacent in the radial direction in a state where the segment conductor 28 protruding from the slot of the stator core is twist-molded at a predetermined angle to form the conductor oblique portion 28D and the conductor welding portion 28E. Here, in the twist-molding, an angle 81 between the end surface of the stator core 21 and the conductor oblique portion 28D, and an angle 82 between the conductor sloping portion 28D and the conductor welding portion 28E are made smaller to preferably reduce the height of the welding-side coil end 62.

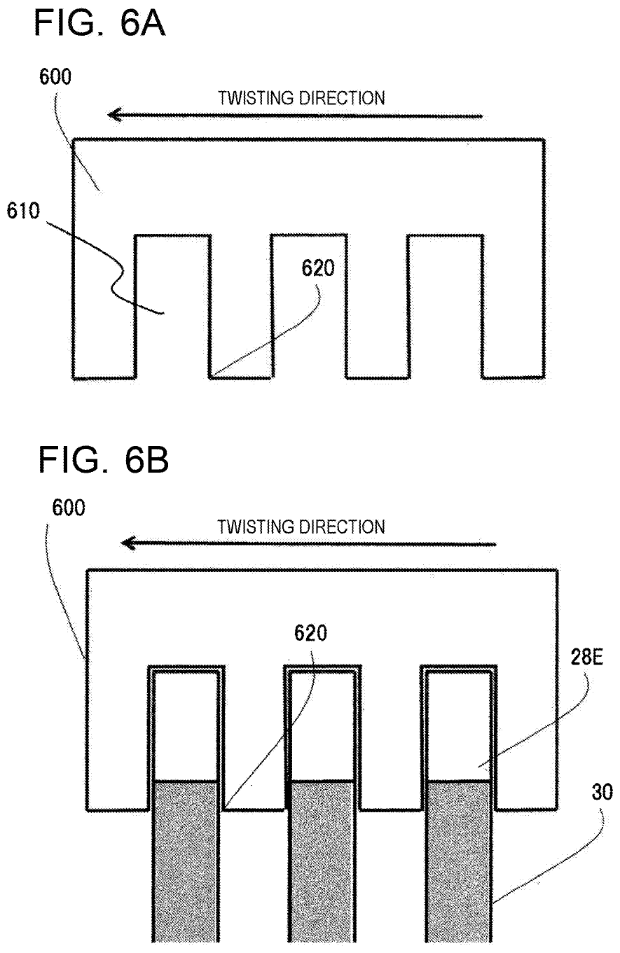

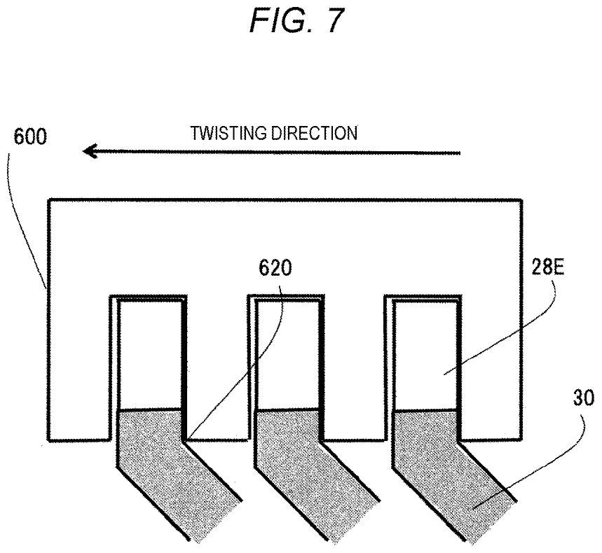

A coil twisting step of twist-molding the end of the segment conductor 28 using a twisting jig 600 of this embodiment will be described with reference to FIGS. 6 and 7. As illustrated in FIG. 6(a), the twisting jig 600 is provided with a groove portion 610 for holding the conductor welding portion 28E of the segment conductor 28 protruding from the slot, and a part of the groove portion 610 has an edge portion which serves as a twisting fulcrum of the segment conductor 28. In addition, the groove width of the groove portion 610 is substantially constant in the depth direction. This is because if there is a gap or a region in the groove of the twisting jig 610 that allows the coil to be tilted, the tilt of the coil after twist-molding tends to vary. As a result, a deviation in the circumferential direction is generated at the position of the coil end portion serving as a joining portion, which causes a reduction in workability when welding overlapping coil end portions. Therefore, the variation in the inclination of the coil after the twisting is suppressed by making the groove portion 610 straight (with a constant groove width).

In the coil twisting step, first, as illustrated in FIG. 6(b), the conductor welding portion 28E of the segment conductor 28 is held by the groove portion 610 of the twisting jig 600. Here, the segment conductor 28 is covered with an insulating coating 30 such as enamel except for a part of the region including the conductor welding portion 28E. In this state, the stator core into which the twisting jig 600 and the segment conductor 28 are inserted is relatively moved in a twisting direction, thereby twisting the segment conductor 28 as illustrated in FIG. 7. At this time, an edge portion 620 of the twisting jig 600 is used as a twisting fulcrum, the edge portion 620 is brought into contact with the segment conductor 28, and a load is applied to the segment conductor to form a press trace of the edge portion 620 on the segment conductor, thereby performing twisting. By adjusting the shape and load of the twisting jig 600 to form the press trace of the edge portion 620 on the segment conductor in this manner, the twisting jig 600 securely holds the segment conductor 28 even during the twisting, so that it is possible to prevent displacement. As a result, even if the angle θ between the end surface of the stator core 21 and the conductor oblique portion 28D and the angle θ2 between the conductor oblique portion 28D and the conductor welding portion 28E are made smaller, the displacement of the conductor welding portion 28E after twisting the segment conductor can be prevented, the welding workability and the connection reliability are excellent, and the coil end can be reduced in size.

### Second Embodiment

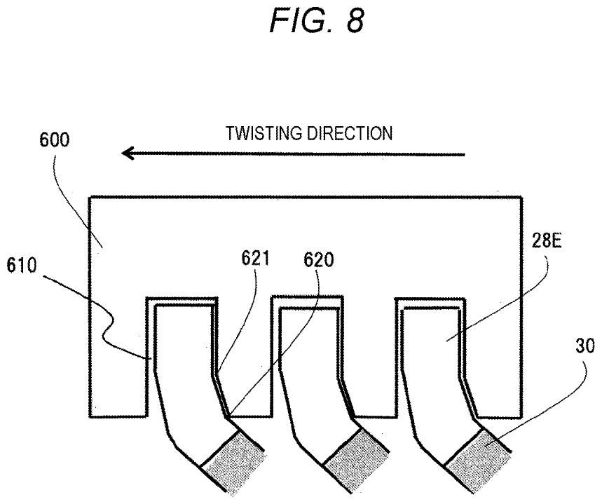

A modification of the twisting jig 600 will be described with reference to FIG. 8. The twisting jig 600 of this embodiment has two edge portions 620 and 621 serving as a twisting fulcrum at a part of the groove portion 610. Further, in the two edge portions 620 and 621, the groove width from the edge portion 621 located on the bottom side of the groove to the bottom of the groove is formed to be substantially constant.

In the coil twisting process, as in the first embodiment, the edge portions 620 and 621 of the twisting jig 600 are used as a twisting fulcrum, and a load is applied to the segment conductor to form the press traces of the edge portions 620 and 621 on the segment conductor using the edge portions 620 and 621 of the twisting jig 600, thereby performing twisting. As described above, even when two edge portions are formed, the same effect as that of the first embodiment can be obtained. Further, since the twisting fulcrum in a bent portion 28K from the conductor oblique portion 28D to the conductor welding portion 28E is dispersed in two places and the segment conductor is bent in a stepwise manner, the bending angle of the segment conductor is gently bent compared to a case where the twisting fulcrum is one place. As a result, it is possible to prevent the insulating coating of the segment conductor 28 from breaking or floating. Further, as the coil end is reduced, the distance between the welding portion and the insulating coating is likely to be short. If there is a damaged portion of the insulating coating, it is likely to be affected by heat during welding. In this embodiment, with the two twisting fulcrums, it is possible to suppress a decrease in the adhesion between the segment conductor and the insulating coating in the bent portion, so that the thermal effect during welding can be reduced.

Further, in the examples of FIGS. 6 and 7, the twist-molding is performed by bringing the insulating film 30 of the segment conductor into contact with the edge portion of the twisting jig 600, but as illustrated in FIG. 8, also possible to perform the twist-molding by bringing the region where the insulating coating 30 of the segment conductor is not formed and the edge portion of the twisting jig 600 into contact with each other. When the exposed portion of the segment conductor is used as a twisting fulcrum, the segment conductor easily bent, which is effective for reducing the coil end.

In this embodiment, an example is described in which two edge portions serving as twisting fulcrums are provided, but three or more edge portions may be provided. When the edge portion is provided at a plurality of places, it is preferable that the press traces corresponding to all the edges are formed on the segment conductor. However, at least one or more press traces may be formed among the plurality of the edges.

As described above, according to the invention, it is possible to provide a method for manufacturing a stator capable of reducing the size of a coil end.

Further, the invention is not limited to the embodiments described above, but includes various modifications. For example, the above embodiments have been described in detail for easy understanding of the invention, and the invention is not necessarily limited to having all the configurations described. In addition, some of the configurations of the embodiments may be omitted, replaced with other configurations, and added to other configurations.

### REFERENCE SIGNS LIST

10 rotating electric machine
11 rotor
12 rotor core
13 rotating shaft
15 slot
20 stator
21 stator core
28 segment conductor
28C non-welding-side coil end vertex
28D conductor oblique portion
28E conductor welding portion
28F conductor oblique portion
28K bent portion
600 twisting jig
610 groove portion
620, 621 edge portion

1. A method for manufacturing a stator that includes a stator core and a stator coil to which ends of a plurality of substantially U-shaped segment coils inserted into slots of the stator core are connected, the method comprising twisting the end of the segment coil using a twisting jig,
wherein, in the twisting, in a state in which the end of the segment coil is inserted into a groove portion of the twisting jig, an edge portion forming a part of the groove portion is used as a twisting fulcrum, and a load is applied to the segment coil to forma press trace of the edge portion on the segment coil.

2. The method for manufacturing the stator according to claim 1, wherein
the groove portion includes the edge portion serving as a twisting fulcrum at a plurality of places, and
a load is applied to the segment coil to form a press trace of the edge portion at the plurality of places on the segment coil.

3. The method for manufacturing the stator according to claim 1, wherein a groove of the twisting jig has a constant groove width in a depth direction.

4. The method for manufacturing the stator according to claim 1, wherein
the segment coil is coated with an insulating coating except for a part of a region including the end, and
a region of the segment coil not covered with an insulating film is brought into contact with the edge portion of the twisting jig to perform twist-molding.
